(19) United States
(12) Patent Application Publication
(10) Pub. No.: US 2007/0206215 A1
(43) Pub. Date: Sep. 6, 2007

(54) Print Control System, Print Attribute Information Management Server, Print Controller, Print Control Method, Recording Medium, And Data Signal

(75) Inventor: Kazuhisa Iwase, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/610,055

(22) Filed: Dec. 13, 2006

(30) Foreign Application Priority Data
Mar. 2, 2006 (JP) 2006-056763

(51) Int. Cl. G06F 3/12

(52) U.S. Cl. 358/1.15

(57) ABSTRACT

A print control system has an information management server that stores and manages print attribute information which is generated with at least a print attribute designated for a data file and identification information of the data file associated with each other; an information generation processor that transmits, to the information management server, a print attribute information registration request including at least a print attribute designated for a data file and identification information of the data file, to thereby instruct storage and management of print attribute information for the data file; and a print execution controller that transmits, to the information management server, a print attribute information acquisition request including identification information of a data file for which printing is requested, and controls execution of printing of the data file in accordance with print attribute information transmitted in response to the print attribute information acquisition request.

### PRIORITY INFORMATION

This application claims priority to Japanese Patent Application No. 2006-056763, filed on Mar. 2, 2006.

### BACKGROUND

1. Technical Field

The present invention relates to a print control system, a print attribute information management server, a print controller, a print control method, a recording medium, and a data signal.

2. Related Art

Recently, with greater functionality of printing functions by an image-forming device such as a multi-function center, many print attributes can be set for an entire document to be printed. This function enables preparation of printed matters of various forms. In addition, the print attribute is not limited to the entire document, and it is now possible to set the print attribute for each of multiple divided sections of a document or to set the print attribute for each page. For example, it is possible to set “2-up” for pages 5-10, color printing for pages 15-20, and A3 size for pages 3 and 21. When there is a possibility that the document for which the print attribute is set in detail is repeatedly printed, a user may wish to store and manage the setting in association with the document in order to avoid erroneous setting and re-inputting of the print attribute.

In the related art, as a method of storing and managing a print attribute for a document, there is known, for example, a method in which each setting of the print attribute is given an individual name and registered in a client PC or a printer (in print service). In the case of the client PC, pasting the set print attribute as a printer icon on the desktop enables easy extraction of the set print attribute.

Alternatively, in place of storing and managing the print attribute for each document, it is also possible to store and manage a print attribute for each user group or for each printer. In addition, there is known a method in which a document and a print attribute are registered in a document management server in association with each other, and the registered information is read and utilized during printing. There is also known a method in which a print attribute is set and registered in accordance with an object of the printed matter, and a setting of the print attribute which matches a predetermined object is read and utilized.

### SUMMARY

According to one aspect of the present invention, there is provided a print control system having an information management server that stores and manages print attribute information which is generated with at least a print attribute designated for a data file and identification information of the data file associated with each other; an information generation processor that transmits, to the information management server, a print attribute information registration request including at least a print attribute designated for a data file and identification information of the data file, to thereby instruct storage and management of the print attribute information for the data file; and a print execution controller that transmits, to the information management server, a print attribute information acquisition request including identification information of a data file for which printing is requested, and controls execution of printing of the data file in accordance with print attribute information transmitted in response to the print attribute information acquisition request.

### BRIEF DESCRIPTION OF THE DRAWINGS

These and other aspects of the disclosure will become apparent from the following description when read in conjunction with the accompanying drawings, wherein the same reference numerals have been applied to like parts and in which:

FIG. 1 is a structural block diagram showing an exemplary embodiment of a print control system according to the present invention;

FIG. 2 is a diagram showing an example setting of history collection information which is set and registered in a history collection information storage in the exemplary embodiment of the present invention;

FIG. 3A is a diagram exemplifying history information for PDF collected in accordance with the setting of the history collection information shown in FIG. 2;

FIG. 3B is a diagram exemplifying history information for TIFF or the like, collected in accordance with the setting of the history collection information shown in FIG. 2;

FIG. 4 is a diagram exemplifying job ticket management information registered in a job ticket management information storage device in the exemplary embodiment of the present invention;

FIG. 5 is a diagram exemplifying display of a job ticket generation screen used in the exemplary embodiment of the present invention;

FIG. 6 is a flowchart showing a registration process of a job ticket in the exemplary embodiment of the present invention;

FIG. 7 is a diagram showing an example of job ticket management information in the exemplary embodiment of the present invention,

FIG. 8 is a flowchart showing a provision process of a job ticket in the exemplary embodiment of the present invention; and

FIG. 9 is a diagram showing an example of RDF generated in the exemplary embodiment of the present invention.

### DETAILED DESCRIPTION

An exemplary embodiment of the present invention will now be described by reference to the drawings.

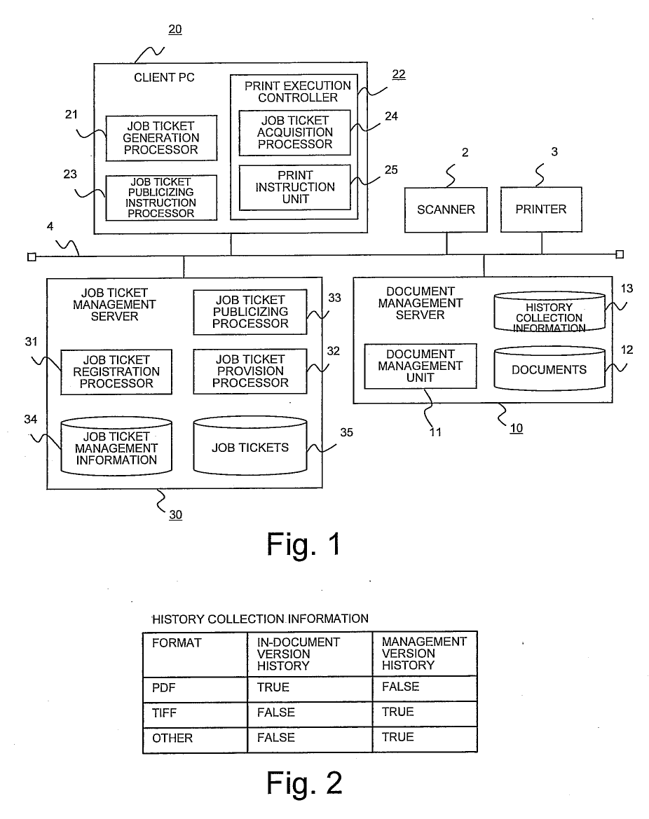

FIG. 1 is a structural block diagram showing an exemplary embodiment of a print control system according to the present invention. FIG. 1 shows a scanner 2, a printer 3, a document management server 10, a client PC 20, and a job ticket management server 30, each of which is connected to a network 4. The scanner 2 is a device which reads a document to be printed. The printer 3 is a device which prints the document to be printed. The printer 3 in the exemplary embodiment is a high-functionality printing device. The printer 3 forms a print image and prints the print image on paper in accordance with print attribute information which is stored in advance or print attribute information which is transmitted with the data to be printed. The print attribute information including the print attribute for printing the data to be printed is transmitted to and received from other devices, such as the client PC 20, in a format of a data file called a job ticket, and is stored in a storage device equipped in the client PC 20. In the exemplary embodiment, the scanner 2 and the printer 3 are shown as separate devices, but the scanner 2 and the printer 3 need not be provided separately, and may be realized by a single image-forming device such as a multi-function center. The network 4 is shown in FIG. 1 as a LAN for the sake of convenience, but the present invention is not limited to such a network configuration.

The document management server 10 is a server computer which collectively stores and manages a data file handled in the system. Because the document management server 10 primarily handles the document data, the exemplary embodiment will be described with an electronic document as a representative data file. The document management server 10 has a document management unit 11, a document database 12, and a history collection information storage device 13. The document management unit 11 manages information handled by the document management server 10. The document database 12 is a storage device in which the electronic document is stored. The history collection information storage device 13 stores information which is set regarding which version information is to be collected as history information of the document to be printed. The document management unit 11 in the document management server 10 is realized through cooperation between a computer forming the document management server 10 and a program running on a CPU equipped in the computer. The storage devices 12 and 13 are realized by external storage devices equipped in the document management server 10.

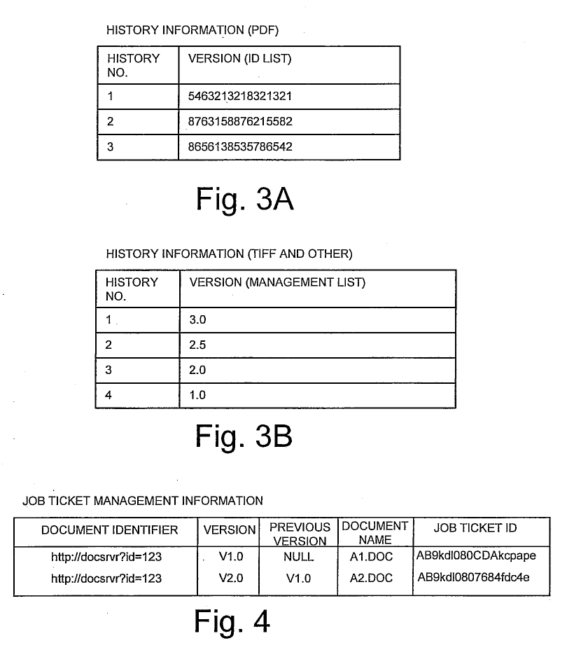

FIG. 2 is a diagram exemplifying a setting of history collection information which is set and registered in the history collection information storage device 13 in the exemplary embodiment. As shown in FIG. 2, the information designates, for each file format, version information to be used as the history information. When an electronic document is revised, a new version is assigned, due to version upgrade. Regarding the information corresponding to the version, for example, in a PDF (Portable Document Format), an ID can be stored within a document, whereas in a TIFF, the ID cannot be stored in the document. Therefore, in the exemplary embodiment, as the version information to be used, a version which is set in the PDF document is used when the format of the electronic document is PDF and a version for managing a document, which is assigned to the TIFF file by a document creator or the document management unit 11, is used when the format of the electronic document is TIFF. When the format of the electronic document is a format other than those described above, the version for managing the document is used. FIG. 2 shows the setting which is set in accordance with such a determination criterion. FIGS. 3A and 3B show examples of history information collected in accordance with the setting shown in FIG. 2. FIG. 3A shows an example of history information for a PDF file in which “TRUE” is set in the in-document version history, with a higher number representing an older version. Therefore, the version for history No. 3 corresponds to a generation ID of the PDF, and versions of the history Nos. 2 and 1 correspond to update IDs of the PDF, respectively. FIG. 3B shows an example of history information for TIFF or other formats in which “TRUE” is set in the management version history, with a higher number representing an older version. Therefore, the version of history No. 4 corresponds to the version when the TIFF file or the like is newly created, and versions of Nos. 3-1 correspond to revisions.

The client PC 20 is a personal computer-used by a user who wishes to print a document, and has a job ticket generation processor 21, a print execution controller 22, and a job ticket publicizing instruction processor 23. The job ticket generation processor 21 receives a designated print attribute through a job ticket generation screen to be described later and generates a job ticket for an electronic document to be newly stored and managed by the document management server 10. The job ticket generation processor 21 then transmits, to the job ticket management server 30, a job ticket registration request including at least the generated job ticket and the identification information of the electronic document, to thereby instruct storage and management of the job ticket for the electronic document. The print execution controller 22 is a unit which controls execution of the printing process, and has a job ticket acquisition processor 24 and a print instruction unit 25. The job ticket acquisition processor 24 transmits, to the job ticket management server 30, a print attribute information acquisition request including the identification information of the electronic document for which printing is requested, to thereby acquire a job ticket to be used for printing the electronic document. The print instruction unit 25 transmits, to the printer 3, the electronic document to be printed, to thereby instruct printing. Simultaneously or prior to the instruction, the print instruction unit 25 transmits a corresponding job ticket to the printer 3. The job ticket publicizing instruction processor 23 transmits, to the job ticket management server 30, a publicizing instruction of the job ticket registered in the job ticket management server 30. The constituent elements 21-23 in the client PC 20 are realized through cooperation between a computer forming the client PC 20 and a program running on a CPU equipped in the computer.

The job ticket management server 30 is a server computer which stores and manages a job ticket corresponding to an electronic document stored and managed by the document management server 10, and has a job ticket registration processor 31, a job ticket provision processor 32, a job ticket publicizing processor 33, a job ticket management information storage device 34, and a job ticket database 35. When the job ticket registration processor 31 receives a job ticket registration request transmitted from the client PC 20, the job ticket registration processor 31 registers to the job ticket database 35 the job ticket included in the job ticket registration request. Simultaneously with this process, information for managing the job ticket is set and registered in the job ticket management information storage device 34. When the job ticket provision processor 32 receives a job ticket acquisition request transmitted from the client PC 20, the job ticket provision processor 32 extracts, from the job ticket database 35, a job ticket which can be identified by the identification information of the electronic document included in the job ticket acquisition request, and transmits the extracted job ticket to the origin of the acquisition request. The job ticket publicizing processor 33 publicizes a corresponding job ticket in response to a job ticket publicizing instruction from the client PC 20.

FIG. 4 is a diagram showing an example of job ticket management information registered in the job ticket management information storage device 34 in the exemplary embodiment of the present invention. In the job ticket management information, a document identifier for identifying an electronic document, a version of the electronic document, an immediately preceding version of the electronic document, a document name of the electronic document, and a job ticket ID for identifying the job ticket corresponding to the electronic document are set in association with each other. In the exemplary embodiment, as the document identifier, storage destination information (a URL) identifying the storage destination of the electronic document is used. The job ticket ID is information necessary for extracting the corresponding job ticket from the job ticket database 35.

The constituent elements 31-33 in the job ticket management server 30 are realized through cooperation between a computer forming the job ticket management server 30 and a program running on a CPU equipped in the computer. The storage devices 34 and 35 are realized by external storage devices equipped in the document management server 10.

Next, an operation in the exemplary embodiment will be described. In the exemplary embodiment, basically, a job ticket for an electronic document is generated in advance; the job ticket management server 40 stores and manages the job ticket; and, when an electronic document is to be printed, the corresponding job ticket is acquired from the job ticket management server 40 and the printing process is executed. First, the registration process of the job ticket will be described, in accordance with the flow of the basic operation.

The registration process of the job ticket is a process in which the client PC 20 transmits to the job ticket management server 30 a registration request including a document attribute and a print attribute, and, in response to the registration request from the client PC 20, the job ticket management server 30 registers, in the job ticket management information storage device 34 and the job ticket database 35, information necessary for managing the job ticket. The electronic document for which a job ticket is to be generated in the exemplary embodiment is a data file locally stored and managed by the user of the client PC 20, a data file stored and managed by the document management server 10, image data generated through a reading operation by the scanner 2, or the like.

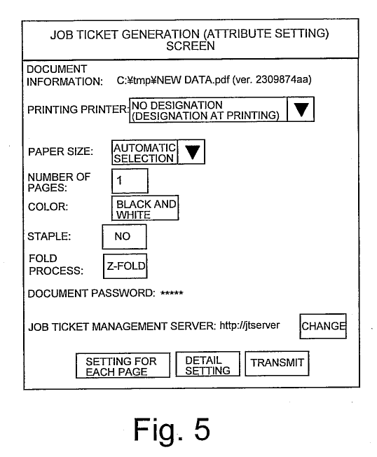

First, when the user of the client PC 20 applies a predetermined starting operation for the job ticket generation process after the user locally generates an electronic document, the job ticket generation processor 21 displays a job ticket generation screen on the display of the client PC 20. FIG. 5 shows an example display of the job ticket generation screen. At the same time, the job ticket generation processor 21 analyzes the electronic document to be processed and extracts the document attribute. The document attribute to be extracted includes at least the document identifier of the document, the document name, and history information. When the setting of the print attribute by the user is completed, the job ticket generation processor 21 generates a job ticket in a predetermined format in accordance with the input setting value. Then, the job ticket generation processor 21 transmits, to the job ticket management server 30, a registration request for the job ticket including the extracted document attribute and the job ticket. In general, the electronic document for which the job ticket is registered and managed is managed by the document management server 10, and, thus, the user also performs the registration process of the electronic document. However, because the storage location of the electronic document can be identified by the document identifier, the registration to the document management server 10 is not a necessary process.

Next, a registration process of a job ticket for an electronic document stored and managed by the document management server 10 will be described. In general, for an electronic document stored and managed by the document management server 10, a job ticket is generated, and stored and managed by the job ticket management server 30. If, however, the user does not perform the print attribute setting operation from the job ticket generation screen as described above, no job ticket would be registered for the electronic document. In this case, the user of the client PC 20 causes a list of documents registered in the document management server 10 to be displayed on the screen, selects from the list an electronic document for which a job ticket is to be associated, and performs a predetermined operation such as right-clicking to cause a job ticket generation menu to be displayed and to select an electronic document. With this selection operation, the job ticket generation screen shown in FIG. 5 is displayed on the screen. The processes after this process are identical with those for a local file, and will not be described again.

Finally, regarding the generation of the job ticket for image data generated through a reading operation of the scanner 2, the basic processes are identical with those in the case when the user of the client PC 20 locally generates an electronic document, except that the electronic document for which a job ticket is to be generated is provided from a scanner 2 in place of the local disk. Thus, the process will not be described again.

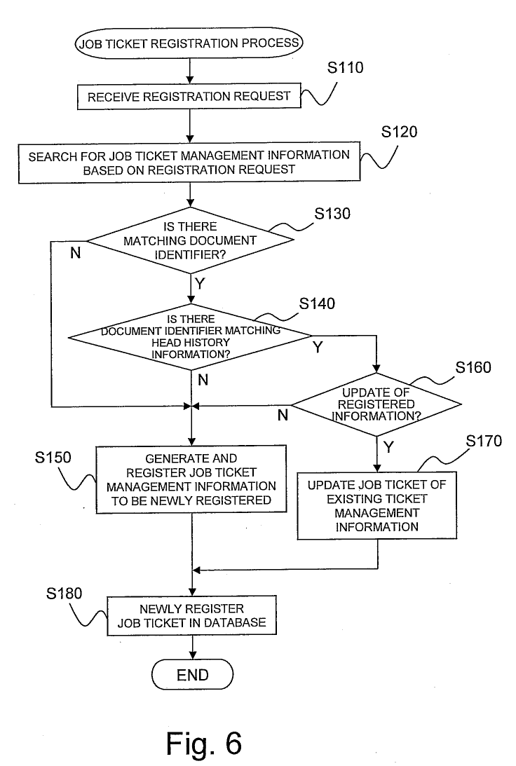

When the client PC 20 transmits, to the job ticket management server 30, a registration request including the document attribute and the print attribute of the electronic document in this manner, the job ticket management server 30 applies the registration process to be described below. The registration process of the job ticket will now be described by reference to a flowchart of FIG. 6.

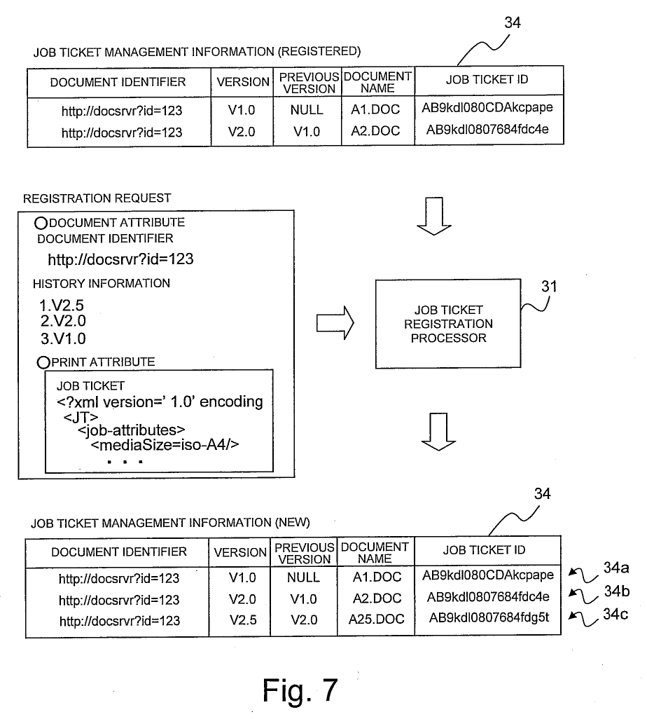

When the job ticket management server 30 receives the registration request transmitted from the client PC 20 (step 110), the job ticket registration processor 31 searches the job ticket management information storage device 34 (step 120), and checks for registered information matching the document identifier included in the registration request. When there is no registered information matching the document identifier (N in step 130), it can be determined that the registration is a new registration of a job ticket related to the document, and, thus, the job ticket registration processor 31 issues a job ticket to be newly registered; more specifically, a new job ticket ID, to the job ticket included in the registration request, to thereby generate and register job ticket management information to which the document attribute included in the registration request is associated (step 150). In the new registration process, because there is no immediately preceding version, “NULL” is set. The job ticket management information generated and registered in this manner would look similar to a record 34a shown in FIG. 7. The job ticket registration processor 31 then registers the job ticket included in the registration request to the job ticket database 35 (step 180).

When, on the other hand, there is registered information matching the document identifier included in the registration request (Y in step 130), a check is made for registered information that matches the head version among the history information included in the registration request. When there is no registered information matching the version (N in step 140), it can determined that this is a new registration request for a job ticket related to the most recent version of the document. Thus, the job ticket registration processor 31 issues a new job ticket. ID for the job ticket to be newly registered, and generates job ticket management information to which the document attribute included in the registration request is associated (step 150). This process is performed, for example, when V1.0 and V2.0 are set in the history information of the registration request and only record 34a is registered in the job ticket management information storage device 34, or when V1.0, V2.0, and V2.5 are set in the history information of the registration request and only records 34a and 34b are registered in the job ticket management information storage device 34. The job ticket management information generated and registered in this manner would look similar to a record 34b or a record 34c shown in FIG. 7. The job ticket registration processor 31 then registers to the job ticket database 35 the job ticket included in the registration request (step 180).

When there is registered information which matches the head version in the history information included in the registration request (Y in step 140), the job ticket registration processor 31 checks whether or not there is a registered update (step 160). This is done by notifying the client PC 20 transmitting the registration request of the status and inquiring the presence of updates. Alternatively, it is also possible to configure the system to apply a predetermined process without inquiring the user of the client PC 20. This process is applied, for example, when V1.0, V2.0, and V2.5 are set in the history information of the registration request and records 34a, 34b, and 34c are registered in the job ticket management information storage 34.

When the registered information is not to be updated (N in step 160), the job ticket registration processor 31 issues a new job ticket ID for the job ticket to be newly registered, and generates job ticket management information to which the document attribute included in the registration request is associated (step 150). The job ticket management information generated in this process differs from the immediately-preceding record only by the job ticket ID. The job ticket registration processor 31 then registers, in the job ticket database 35, the job ticket included in the registration request (step 180).

When, on the other hand, the registered information is to be updated (Y in step 160), the job ticket registration processor 31 issues a new job ticket ID for the job ticket to be newly registered, and updates the job ticket ID of the existing record (step 170). The “existing record” refers to the most recent record. For example, when the records 34a-34c are registered in the job ticket-management information storage 34, the “existing record” refers to the record 34c.

In this manner, by the job ticket being registered in the job ticket management server 30, the job ticket management server 30 collectively stores and manages the job tickets related to electronic documents.

Next, a process performed during printing in the exemplary embodiment will be described.

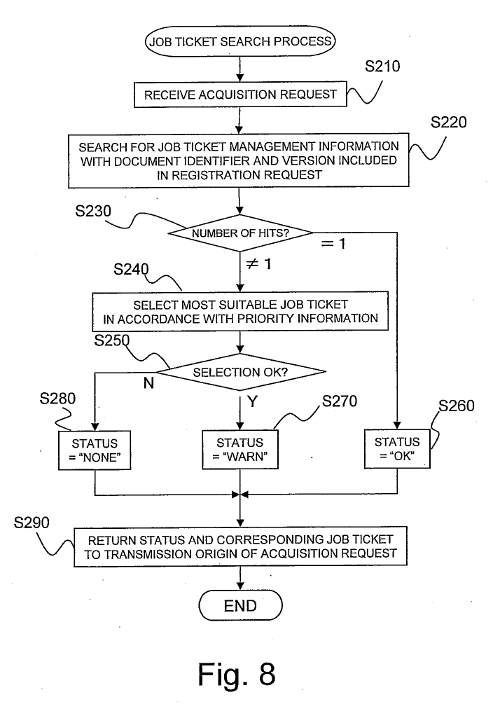

The job ticket acquisition processor 24 in the client PC 20 extracts the document identifier and the version of the electronic document to be printed from the inside or acquires the document identifier and the version from the document management server 10 in accordance with a user operation, and transmits, to the job ticket management server 30, an acquisition request of the job ticket including the document identifier and the version. A provision process of the job ticket at the job ticket management server 30 for returning, to the requesting origin, a job ticket in response to the acquisition request will now be described by reference to the flowchart shown in FIG. 8.

When the job ticket management server 30 receives the acquisition request transmitted from the client PC 20 (step 210), the job ticket provision processor 32 searches the job ticket management information storage device 34, to check whether or not there is registered information (record) which matches the document identifier and version included in the acquisition request (step 220). When one record of information which hits is registered (“=1” in step 230), “OK”, which indicates that there is one corresponding record, is set as the status to be returned to the acquisition request transmission origin (step 260).

When the number of registered records of information which hits is not one (“≠1” in step 230), different cases can be considered, one of which is a case in which no corresponding record is registered, and another of which is a case in which multiple records are registered. In this case, in the exemplary embodiment, a job ticket among the registered job ticket which is considered the most suitable is selected in response to the acquisition request, in accordance with a predetermined selection criterion.

When there is no record in which the search condition for the document identifier and the version designated in the acquisition request matches (when number of hits is 0), the search condition is loosened and the job ticket management information storage 34 is again searched. For example, the search is again performed with only the document identifier. In other words, the selection criterion can be considered to have a higher priority for the document identifier than that for the version. In this manner, an electronic document which matches the document identifier may be found. When there are multiple versions, multiple records would hit. Thus, when a selection criterion is set such that a most recent version is selected when multiple records hit, the most recent version is selected in accordance with this setting. If a most suitable job ticket can be selected in accordance with the priority information as described above (“Y” in step 250), “WARN” is set as the status to be returned, indicating that although a record that matches the acquisition request was not found, a most suitable (here, a most recent version) job ticket has been found and is to be returned (step 270). When, on the other hand, no job ticket can be selected with the search conditions changed in accordance with the priority information (“N” in step 250), “NONE” is set as the status to be returned, indicating that no corresponding job ticket is registered (step 280).

The job ticket provision processor 32 extracts, from the job ticket database 35, the status obtained through the above-described process and the corresponding job ticket when the status differs from “NONE”, and returns the same to the client PC 20 which is the origin of the acquisition request (step 290).

When the job ticket acquisition processor 24 acquires the job ticket in this manner in the client PC 20, the print instruction unit 25 executes a process in accordance with the status. For example, when the status is “OK”, the print instruction unit 25 instructs the printing process by unconditionally transmitting to the printer 3 the acquired job ticket and the electronic document to be printed. When the status is “NONE”, the print instruction unit 25 notifies the user of the status by, for example, displaying on the screen, and transits the same to, for example, a job ticket generation process in accordance with the user's instruction operation. When the status is “WARN”, the print instruction unit 25 notifies the user of the status by, for example, displaying on the screen, and inquires the user as to whether or not the document is to be printed. When the user indicates that the document is to be printed, the print instruction unit 25 notifies the printer 3 of the printing process, similar to the case when the status is “OK”. When, on the other hand, the user indicates that the document is not to be printed, the print instruction unit 25 applies a process similar to the case when the status is “NONE”.

The printer 3 performs a printing process for the electronic document to be printed, in accordance with the print attribute designated in the acquired job ticket. When storage destination information such as a URL has been transmitted instead of the actual electronic document, the printer 3 acquires the corresponding electronic document from the document management server 10 by referring to the storage destination information and performs the printing process.

The exemplary embodiment has been configured such that the job ticket is collectively managed, the job ticket related to a document to be printed is extracted each time the document is to be printed, and the printing process is performed. Although the user who generated and registered the document knows that the job ticket corresponding to the document is registered in the job ticket management server 30, a user who wishes to view the document does not necessarily know that the document is registered. For this purpose, in the exemplary embodiment, information related to the job ticket is publicized, to thereby improve usability of the job ticket. This process will now be described.

After the job ticket is registered in the job ticket management server 30 in the above-described job ticket registration process, a user who desires publication of the job ticket transmits, to the job ticket management server 30, a publicizing request including information for identifying the job ticket, such as the document identifier and the job ticket ID.

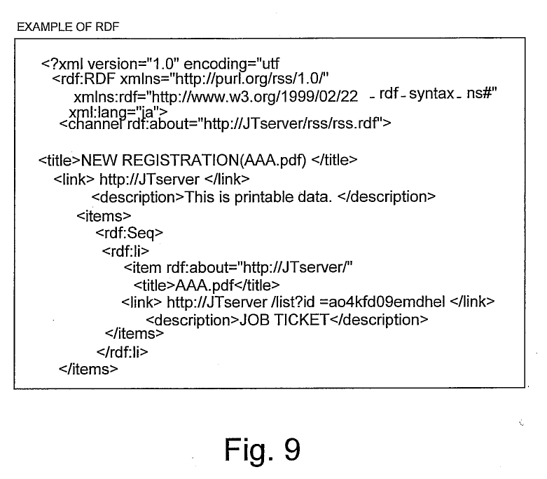

When the job ticket management server 30 receives the publicizing request transmitted from the client PC 20 (step 110), the job ticket publicizing processor 33 identifies a job ticket which matches the document identifier or the like included in the publicizing request, creates URL (Uniform Resource Locator) information for identifying the job ticket and a RSS (RDF (Resource Description Framework) Site Summary) document, and publicizes the created information on a web server. When the information is publicized on a web server, the job ticket management server 30 creates information related to the job ticket (document attribute and print attribute) and a URL for identifying the job ticket in the RDF format. FIG. 9 shows an example of this information in the RDF format. Alternatively, when a target document of the corresponding job ticket is present in the document management server 10, it is also possible to change the information into other print attribute (ipp) along with the URL of the target document and attach link destination information for download, and publicize the information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A print control system comprising:
an information management server that stores and manages print attribute information which is generated with at least a print attribute designated for a data file and identification information of the data file associated with each other;
an information generation processor that transmits, to the information management server, a print attribute information registration request including at least a print attribute designated for a data file and identification information of the data file, to thereby instruct storage and management of print attribute information for the data file; and
a print execution controller that transmits, to the information management server, a print attribute information acquisition request including identification information of a data file for which printing is requested, and controls execution of printing of the data file in accordance with print attribute information transmitted in response to the print attribute information acquisition request.

2. A print attribute information management server comprising:
an information storage unit that stores print attribute information which is generated with at least a print attribute designated for a data file and identification information of the data file associated with each other;
an information registration processor that registers, in the information storage unit, print attribute information included in print attribute information registration request including at least a print attribute designated for a data file and identification information of the data file when the print attribute information registration request is received; and
an information provision processor that extracts, from the information storage unit, print attribute information which can be identified by identification information of a data file included in a print attribute information acquisition request including the identification information of the data file when the print attribute information acquisition request is received, and transmits the extracted print attribute information to a transmission origin of the acquisition request.

3. The print attribute information management server according to claim 2, wherein
the identification information of the data file is information related to a file attribute, and
the print attribute information further includes information related to a file attribute of the data file.

4. The print attribute information management server according to claim 2, wherein
the information provision processor selects print attribute information in accordance with a predetermined selection criterion when no print attribute information matching the identification information of the data file included in the received print attribute information acquisition request is registered in the information storage unit.

5. The print attribute information management server according to claim 2, wherein
the information provision processor notifies the transmission origin of the print attribute information acquisition request of the presence/absence of registration of print attribute information which matches the identification information of the data file included in the received print attribute information acquisition request.

6. A print controller comprising:
an information generation processor that transmits a print attribute information registration request including at least a print attribute designated for a data file and identification information of the data file to an information management server which stores and manages print attribute information generated with at least a print attribute designated for a data file and identification information of the data file associated with each other, to thereby instruct storage and management of the print attribute information for the data file; and
a print execution controller that transmits, to the information management server, a print attribute information acquisition request including identification information of a data file for which printing is requested, and controls execution of printing of the data file in accordance with print attribute information transmitted in response to the print attribute information acquisition request.

7. A method of controlling printing, comprising:
transmitting, from a client to an information management server, a registration request of print attribute information including at least a print attribute designated for a data file and identification information of the data file;
registering, in an information storage unit, print attribute information included in a print attribute information registration request when the print attribute information registration request is received by the information management server;
transmitting, from a print controller, which sends a printing instruction to a printing device, to the information management server, an acquisition request of print attribute information including identification information of a data file for which printing is requested;
extracting, when the information management server receives a print attribute information acquisition request including identification information of a data file, from the information storage unit, print attribute information which can be identified by identification information of a data file included in the print attribute information acquisition request, and transmitting the extracted print attribute information to a transmission origin of he acquisition request; and
controlling, by the print controller, execution of printing of the data file in accordance with print attribute information transmitted in response to the print attribute information acquisition request.

8. A computer readable recording medium storing a program causing a computer to execute a process comprising:
storing, in an information storage unit, print attribute information which is generated with at least a print attribute designated for a data file and identification information of the data file associated with each other;
registering, when a print attribute information registration request including at least a print attribute designated for a data file and identification information of the data file is received, in the information storage unit, print attribute information included in the print attribute information registration request; and
extracting, when a print attribute information acquisition request including identification information of a data file is received, from the information storage unit, print attribute information which can be identified by the identification information of the data file included in the print attribute information acquisition request, and transmitting the extracted print attribute information to a transmission origin of the acquisition request.

9. A computer readable storage medium storing a program causing computer to execute a process comprising:
transmitting, to an information management server which stores and manages print attribute information which is generated with at least a print attribute designated for a data file and identification information of the data file associated with each other, a print attribute information registration request including at least a print attribute designated for a data file and identification information of the data file, to thereby instruct storage and management of print attribute information for the data file; and
transmitting, to the information management server, a print attribute information acquisition request including identification information of a data file for which printing is requested, and controlling execution of printing of the data file in accordance with print attribute information transmitted in response to the print attribute information acquisition request.

10. A computer data signal embodied in a carrier wave for enabling a computer to execute a process comprising:
storing, in an information storage unit, print attribute information which is generated with at least a print attribute designated for a data file and identification information of the data file associated with each other;
registering, when a print attribute information registration request including at least a print attribute designated for a data file and identification information of the data file is received, in the information storage unit, print attribute information included in the print attribute information registration request; and
extracting, when a print attribute information acquisition request including identification information of a data file is received, from the information storage unit, print attribute information which can be identified by the identification information of the data file included in the print attribute information acquisition request, and transmitting the extracted print attribute information to a transmission origin of the acquisition request.

11. A computer data signal embodied in a carrier wave for enabling a computer to execute a process comprising:
transmitting, to an information management server which stores and manages print attribute information which is generated with at least a print attribute designated for a data file and identification information of the data file associated with each other, a print attribute information registration request including at least a print attribute designated for a data file and identification information of the data file, to thereby instruct storage and management of print attribute information for the data file; and
transmitting, to the information management server, a print attribute information acquisition request including identification information of a data file for which printing is requested, and controlling execution of printing of the data file in accordance with print attribute information transmitted in response to the print attribute information acquisition request.
